(19) United States
(12) Patent Application Publication
(10) Pub. No.: US 2024/0406072 A1
(43) Pub. Date: Dec. 5, 2024

(54) SYSTEMS AND METHODS FOR RECONFIGURABLE NETWORKS

(71) Applicant: Microsoft Technology Licensing, LLC, Redmond, WA (US)

(72) Inventors: Nitin BHARDWAJ, Redmond, WA (US); James Jui-Lin YU, Seattle, WA (US)

(21) Appl. No.: 18/203,606

(22) Filed: May 30, 2023

(51) Int. Cl. H04L 41/12

(52) U.S. Cl. CPC H04L 41/12

(57) ABSTRACT

At a topology controller, a method may: receive a topology request at the topology controller, based at least partially on the topology request, select an input-output (I/O) link connecting an input node to a destination node from a plurality of I/O links including at least: a direct I/O link between the input node and the destination node, and a switched I/O link between the input node and the destination node, and configure an active I/O link between the input node and the destination node based on the selected I/O link.

### BACKGROUND

Network switches in a network topology introduce latency into the network communications between computational nodes. In distributed computational systems, the latency of the network switches can significantly reduce the efficiency of communication and increase computation time.

### BRIEF SUMMARY

In some aspects, the techniques described herein relate to a method of managing communication between computing nodes, the method including: at a topology controller: receiving a topology request at the topology controller; based at least partially on the topology request, selecting an input-output (I/O) link connecting an input node to a destination node from a plurality of I/O links including at least: a direct I/O link between the input node and the destination node, and a switched I/O link between the input node and the destination node; and configuring an active I/O link between the input node and the destination node based on the selected I/O link.

In some aspects, the techniques described herein relate to a system for managing a topology of a distributed computing system, the system including: an input node; a destination node; a first topology switch associated with the input node and in data communication with the input node; a second topology switch associated with the destination node and in data communication with the destination node; and a topology controller configured to actuate at least the first topology switch to selectively direct information from the input node to one of: a direct I/O link between the first topology controller and the second topology controller, and a switched I/O link between the first topology controller and the second topology controller.

In some aspects, the techniques described herein relate to a method of managing communication between computing nodes, the method including: receiving a computational process request at a machine learning model; determining at least part of a topology request with the machine learning model; and at a topology controller: receiving the topology request at the topology controller; based at least partially on the computational process request, selecting an input-output (I/O) link connecting an input node to a destination node from a plurality of I/O links including at least: a direct I/O link between the input node and the destination node, and a switched I/O link between the input node and the destination node; and configuring an active I/O link between the input node and the destination node based on the selected I/O link.

This Summary is provided to introduce a selection of concepts in a simplified form that are further described below in the Detailed Description. This Summary is not intended to identify key features or essential features of the claimed subject matter. Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a distributed computing system with an “any-to-any” topology, according to at least one embodiment of the present disclosure.

FIG. 2 is a distributed computing system with an all direct link topology, according to at least one embodiment of the present disclosure.

FIG. 3 is a distributed computing system with a mixed topology of a, according to at least one embodiment of the present disclosure.

FIG. 4 is a flowchart illustrating a method of managing a topology of a distributed computing system, according to at least one embodiment of the present disclosure.

FIG. 5 illustrates an embodiment of a system for management of the topology of at least a portion of a distributed computing system, according to at least one embodiment of the present disclosure.

FIG. 6 is schematic diagram of a machine learning model that may be trained to manage the topology and/or determine a topology request for the topology controller, according to at least one embodiment of the present disclosure.

FIG. 7 is an example of a ring topology of an embodiment of a portion of a distributed computing system, according to at least one embodiment of the present disclosure.

FIG. 8 is an example of a tree topology of an embodiment of a portion of a distributed computing system, according to at least one embodiment of the present disclosure.

FIG. 9 is an example of a hybrid topology of an embodiment of a portion of a distributed computing system, according to at least one embodiment of the present disclosure.

### DETAILED DESCRIPTION

The present disclosure relates generally to systems and methods for increasing computational efficiency of a distributed computing system. More particularly, the present disclosure relates to a reconfigurable network and methods of reconfiguring the network to provide more efficient data communication between a plurality of computational nodes. In some embodiments, a distributed computing system or other high-performance computing (HPC) system includes a plurality of computational nodes, accelerators, or other computing devices that each perform a part of the total computational task. In some examples, the different computing devices of the distributed computing system contain identical hardware, such as processors, hardware storage devices including one or both of volatile memory and non-volatile memory, communication devices, power supplies, thermal management devices, and other electronic components. In some examples, the different computing devices of the distributed computing system contain different hardware, allowing certain computing devices to complete certain portions of the total computational task faster or more efficiently, such as consuming less electrical power or generating less heat.

In some embodiments, the distributed computing system allocates different portions of the computing task to different computing devices, and inputs and/or outputs of the different portions of the computing task are transmitted between the computing devices. For example, a first computing device of the distributed computing system performs a first portion of the computing task and transmits an output of the first portion to a second computing device as an input to the second portion of the computing task performed at the second computing device. In some examples, a specialized computing device performs a first portion of the computing task while obtaining inputs from a plurality of other computing devices on-demand. In some examples, the network topology (e.g., the communication links between the computing devices of the distributed computing system) change as needed for the computing task.

In some embodiments of a network according to the present disclosure, a topology controller manages one or more communication links in the distributed computing system based at least partially on a requested computing task and the computing devices of the distributed computing system that are available, contain relevant data, or are most efficient at performing certain functions.

In some embodiments, the requested computing task uses a plurality of computing devices for an extended period of time. For example, the requested computing task may include artificial intelligence (AI) tasks, such as generative AI or large language model (LLM) tasks, or the requested computing task may include training a machine learning model. For example, training a LLM on a corpus of data may require weeks of processing time. Increases in communication efficiency between computing devices of the distributed computing system may save hours or days of processing time of the total computational task.

Network switches, such as network switches, allow any of the computing devices to communicate with any other computing device in the distributed computing system. Network switching is a communication method where data is divided into smaller units called packets and transmitted through a communication link to another computing device. Each packet contains the source and destination addresses, as well as other information needed for routing through the network. The packets may take different paths to reach their destination, and they may be transmitted out of order or delayed due to network congestion. Network switching may result in further delays as the packets are received and recompiled at the destination. In some examples, packets are dropped, causing delays or errors in the transmitted information.

In some embodiments, a direct communication link provides a dedicated communication path through the network that is not subject to and/or less subject to network latency variability, network congestion, and interference. For example, circuit switching is a communication method where a dedicated communication path, or circuit, is established between two devices before data transmission begins. The circuit remains dedicated to the communication for the duration of the session, and no other devices can use it while the session is in progress. Circuit switching can therefore reduce latency between a first computing device and a second computing device by eliminating competition on the same channels, where network switching may be delayed due to Quality of Service (QOS) levels or other competition for transmission time. Additionally, circuit switching can further reduce delays by reducing and/or eliminating time related to the division of the data into packets, recompiling of the packets, and any errors associated therewith.

Systems and methods according to the present disclosure include a topology controller receiving a computational task request for the distributed computing system. The topology controller is in data communication with one or more topology switches, such as cross-switches, that allow the topology controller to select and/or implement a network topology based at least partially on the requested computing task. In some embodiments, the topology controller is a dedicated computing device that controls the network switch topology. In some embodiments, the topology controller is part of an allocator, such as a virtual machine allocator, or other control plane that controls the computing task(s) assigned to one or more of the computing devices in the distributed computing system.

In some embodiments, the distributed computing system is predefined, such as a distributed computing system including a plurality of computing devices and/or computing nodes co-located in a server rack, a server row, a datacenter, a region including a plurality of datacenters, etc. In some examples, the distributed computing system includes a variety of different computing devices and/or computing nodes with different hardware or software that allow some to be relatively more efficient at performing a particular computing task and/or allow for a more specialized operation of the different computing devices. For example, a first computing node may be relatively more efficient at graphical processing than a second computing node. In another example, a first computing node may be relatively more efficient at database querying and management than a second computing node.

In some embodiments, the distributed computing system is ad hoc, such as a distributed computing system including a plurality of general-purpose server computers that are selected and allocated to the requested computing task. In such examples, the general-purpose computers may have identical hardware and/or software. In some examples, the general-purpose computer may have different hardware or software that allows some to be relatively more efficient at performing a particular computing task and/or allow for a more specialized operation. In some embodiments, an ad hoc distributed computing system includes computing devices and/or computing nodes selected from a pool of available devices based at least partially on the hardware configuration and/or software configuration of the computing devices and/or computing nodes.

A device inventory includes information relating to the hardware configuration and/or software configuration of the computing devices and/or computing nodes. In some embodiments, a topology controller obtains a device inventory of the computing devices and/or computing nodes of the distributed computing system. For example, the topology controller may access the device inventory from another computing device, such as the allocator that allocates processes to the computing devices and/or computing nodes. In some examples, the topology controller has a device inventory stored locally on a hardware storage device of the topology controller. In some examples, the topology controller dynamically creates a device inventory based at least partially on available computing devices and/or computing nodes in the pool, such as available server computers within a datacenter.

The topology of the distributed computing system includes the number, endpoints, and types of I/O links in the distributed computing system. For example, the distributed computing system may include a plurality of computing devices, such as server blades. In some embodiments, a computing device is a computing node. In some embodiments, a computing device includes a plurality of computing nodes, such as multiple processors on a single server blade. The topology of the distributed computing system includes the I/O links between the computing nodes and, in some examples, the direction of the I/O links. For example, an I/O link between a first computing node and a second computing node may communicate data from the first computing node to the second computing node. In some examples, an I/O link between a first computing node and a second computing node may communicate data from the first computing node to the second computing node and from the second computing node to the first computing node.

While computing nodes in various systems and methods according to the present disclosure may refer to input nodes and destination nodes, it should be understood that any I/O link between the input node and the destination node may be bi-directional and the terms input node and destination node refer to the direction of communication of some information. For example, a first computing node may be an input node that inputs data to a first I/O link and a second computing node may be an destination node that receives the data from the first I/O link. The second computing node may then input data to the first I/O link and the first computing node may be the destination node that receives the data from the first I/O link. In another example, a first computing node may be an input node that inputs data to a first I/O link and a second computing node may be an destination node that receives the data from the first I/O link. The second computing node may then input data to a second I/O link and a third computing node may be an destination node that receives the data from the second I/O link.

The topology of the distributed computing system includes the type of I/O link between computing nodes. For example, the distributed computing system may include a direct I/O link, a switched I/O link, or other types of I/O links. In some embodiments, a direct I/O link is a circuit switched I/O link that provides a dedicated and substantially continuous I/O link between the first computing node and the second computing node. In some embodiments, a switched I/O link is a network switched I/O link that provides a versatile I/O link that can provide communication between a first computing node (e.g., input node) and a plurality of computing nodes (e.g., destination nodes), as needed. The latency of the direct I/O link is less than the latency of the switched I/O link. However, the direct I/O link commits networking and compute resources to the direct I/O link of the first computing node and the second computing node.

In some embodiments, a topology controller selects and/or changes a topology of the distributed computing system to reduce the total latency in the distributed computing system and improve communication efficiency and computing efficiency of the distributed computing system. For example, the topology controller selects a topology for the distributed computing system and changes at least one I/O link from a direct I/O link to a switched I/O link or at least one switched I/O link to a direct I/O link.

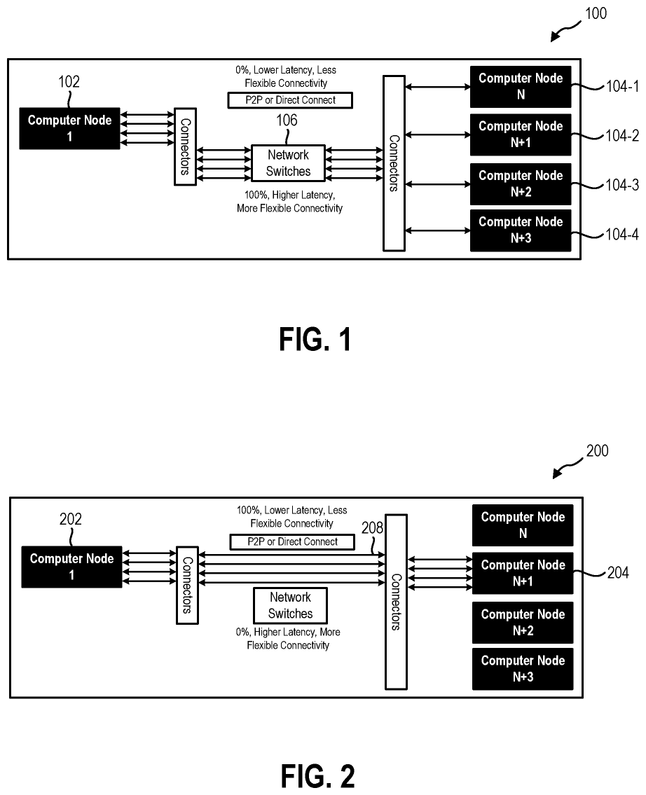

In some embodiments, the distributed computing system includes switched I/O links to provide the flexibility in communications. FIG. 1 is an all switched I/O link “any-to-any” topology. For example, an “any-to-any” topology is a distributed computing system 100 in which all computing nodes are in data communication with one another via switched I/O links. The any-to-any topology allows communication between the input node 102 and any destination node 104-1, 104-2, 104-3, 104-4 at any time by routing the data packets to the network switch 106, which then interprets information in the packet and routes the packet to the appropriate destination node 104-1, 104-2, 104-3, 104-4. The destination node 104-1, 104-2, 104-3, 104-4 can then receive and recompile the packets.

While the any-to-any switched I/O link topology is versatile in communications, the latency associated with packet transmissions on the any-to-any switched I/O link topology is greater than 200 nanoseconds with many conventional network switches 106 introducing a latency of 1 microsecond or more just for header processing to direct the packets. In some embodiments, dropped packets and/or recompiling can introduce additional latency and/or errors.

In some embodiments, the distributed computing system includes direct I/O links to provide low latency communications between input nodes and destination nodes. FIG. 2 is an embodiment of an all direct link topology of a distributed computing system 200. In examples where the first computing node (input node 202) and the second computing node (destination node 204) are transmitting large blocks of data therebetween or frequent communications therebetween, the direct I/O links 208 can allow faster communication with lower latency than a switched I/O link. For example, a direct I/O link may have a latency of approximately 1 nanosecond between the input node 202 and the destination node 204. Additionally, direct I/O links 208 may allow less opportunities for errors in the transmission, as the direct I/O links 208 do not require dividing the data into packets, nor does the transmission pass through multiple potential routes to the destination node.

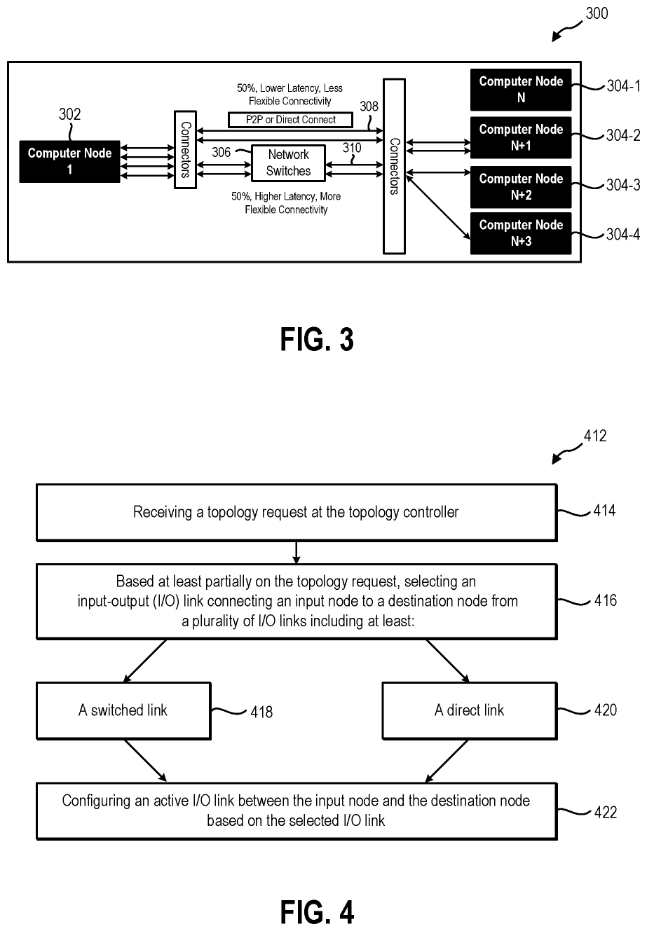

FIG. 3 is an embodiment of mixed topology of a distributed computing system 300 including some direct I/O links 308 and some switched I/O links 310. For example, the input node 302 has a plurality of direct I/O links 308 between the input node 302 and the first destination node 304-1 allowing for low-latency, high reliability data communication, and the input node 302 has a plurality of switched I/O links 310 through a network switch 306 that allow packets to be routed to any of a plurality of destination nodes 304-1, 304-2, 304-3, 304-4 in the distributed computing system. In some embodiments of systems and methods according to the present disclosure, a distributed computing system changes at least a portion of the topology based at least partially on an assigned computing task.

FIG. 4 is a flowchart illustrating a method 412 of managing a topology of a distributed computing system. The method includes receiving a topology request at a topology controller at 414. In some embodiments, receiving a topology request includes receiving a computational process request at the topology controller, and the topology controller calculates or determines a topology request based at least partially on the computational process request. The computational process may be a computational task or a portion of a computational task. The computational process request may inform the topology controller of the subprocesses and/or subtasks required in the computational process. In some embodiments, the computational process request informs the topology controller of the amount of data being processed. In some embodiments, the computational process request informs the topology controller of the quantity of computing nodes required.

In some embodiments, receiving a topology request at a topology controller includes receiving the topology request from an allocator or other module that calculates or determines the topology request based at least partially on the computational process request. In some embodiments, as will be described herein, the topology request is determined by a machine learning model. In some embodiments, the topology request includes a fixed link topology. For example, a fixed link topology may include a ring topology, a tree topology, a star topology, a hierarchical topology, or other topologies.

Based at least partially on the topology request, the method further includes selecting an I/O link connecting an input node to a destination node from a plurality of I/O links at 416. The selected I/O link is one of at least a direct link 420 between the input node and the destination node and a switched link 418 between the input node and the destination node, such as described herein.

In some embodiments, selecting the I/O link is based at least partially on a device inventory. A device inventory includes information relating to the hardware configuration and/or software configuration of the computing devices and/or computing nodes. In some embodiments, a topology controller obtains a device inventory of the computing devices and/or computing nodes of the distributed computing system. For example, the topology controller may access the device inventory from another computing device, such as the allocator that allocates processes to the computing devices and/or computing nodes. In some examples, the topology controller has a device inventory stored locally on a hardware storage device of the topology controller. In some examples, the topology controller dynamically creates a device inventory based at least partially on available computing devices and/or computing nodes in the pool, such as available server computers within a datacenter.

In some embodiments, selecting the I/O link is based at least partially on a data inventory. A data inventory includes information relating to the data stored on various hardware storage devices of the distributed computing system. For example, different computing devices of the distributed computing system may have different data stored thereon. In instances where computations are to be performed on the stored data, the stored data may need to be transferred to another computing node of the distributed computing system for more or most efficient processing. In at least one example, selecting the I/O link(s) include referencing both a data inventory and device inventory to select an I/O link from an input node (e.g., containing data based at least partially on the data inventory) to a destination node (e.g., based at least partially on the device inventory) for processing.

In some embodiments, selecting the I/O link is based at least partially on a computational process request. In some embodiments, the computational process request includes a specialized computational subprocess that is more efficiently performed on a specialized computing node, which affects the topology request. In some embodiments, the computational process request includes computational subprocesses that are performed in sequence, such as each output being an input into a future subprocess. In the event that the output of a first subprocess is consistently provided as an input to a second subprocess, the topology request may instruct the topology controller to establish a direct I/O link between a first computing node performing the first subprocess such that the output is transmitted on the direct I/O link to a second computing node performing the second subprocess.

In some embodiments, the method further includes configuring an active I/O link between the input node and the destination node based on the selected I/O link with a topology switch at 422. In some embodiments, configuring the active I/O link includes actuating the topology switch, such as a cross-point switch. For example, a 2×2 cross-point switch allows recabling of the active I/O link. In an example, the method includes changing a switched I/O link to a direct I/O link by bypassing the network switch with a cross-point switch. In some embodiments, actuating the topology switch introduces latency into the topology of the distributed computing system because the actuation and recabling requires an actuation time that may be orders of magnitude longer than the latency associate with network switching. However, the reduction in latency of the direct I/O link when the versatility of a switched I/O link is not necessary can quickly compensate for the 1-2 millisecond actuation time. In some embodiments, the method further includes transmitting data on the active I/O link from the input node to the destination node.

In some embodiments, the method further allows the topology controller to send instructions and/or commands to power down the network switches (e.g., network switches) of the switched I/O links when the network switches are not used. For example, when the active I/O link is a direct I/O link and bypasses the network switch, the topology controller may provide instructions to power down or place into a standby state the network switch, conserving power. In some embodiments, the topology controller transmits the instructions to the network switch to power down the network switch. In some embodiments, the topology controller transmits the instructions to a rack manager, row manager, or other control plane in data communication with the network switch to power down the network switch.

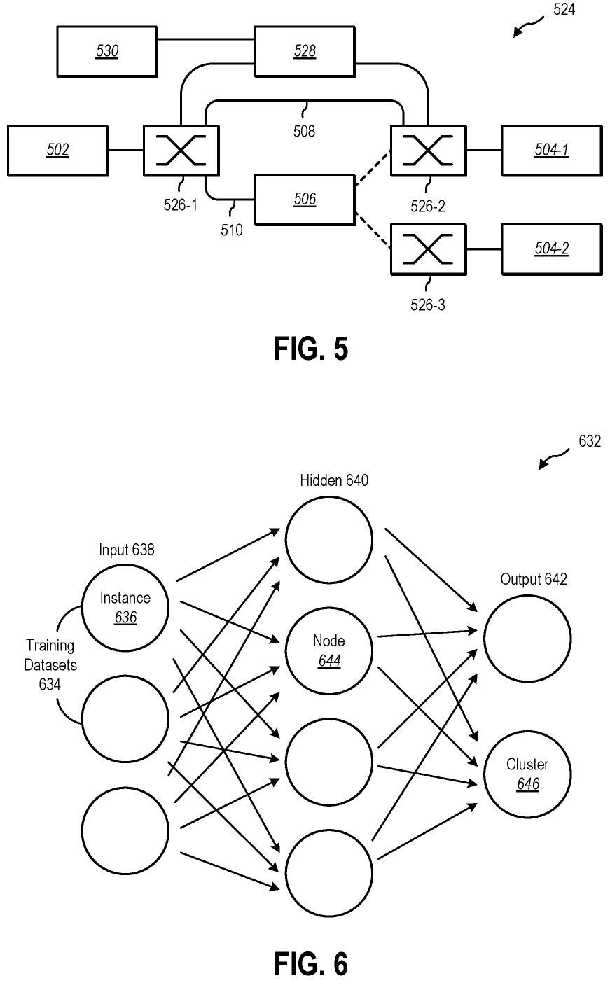

FIG. 5 illustrates an embodiment of a system 524 for management of the topology of at least a portion of a distributed computing system 500. In some embodiments, a distributed computing system 500 according to the present disclosure includes at least one input node 502 and a plurality of destination nodes 504-1, 504-2. The distributed computing system 500 includes I/O links that allow either direct I/O links 508 or switched I/O links 510 through a network switch 506 to be selectively configured between the input node 502 and the destination node(s) 504-1, 504-2. In some embodiments, the distributed computing system includes at least one topology switch 526.

The topology switch 526 allows the I/O link to be changed between states. In some embodiments, the topology switch 526 physically recables a wired connection between the input node 502 and the destination node 504-1, 504-2. In some embodiments, the topology switch 526 is a cross-point switch. In some embodiments, the cross-point switch is a 2×2 cross-point switch. In some embodiments, the cross-point switch is a 4×4, 8×8, 16×16, or greater cross-point switch. Increasing the size of the cross-point switch, however, can limit the available space for computing devices and/or other electronic components of the distributed computing system 500. A 2×2 cross-point switch allows for the selection of a switched I/O link 510 and a direct I/O link 508 for a computing node and/or computing device without substantially impairing the available space for other devices. For example, the physical connection between the input node and the destination node may be made by electrical cables, such as active or passive DAC cables) running any network transport layer protocol (e.g., Ethernet, ROCE).

In some embodiments, the system 524 includes a topology switch 526-1, 526-2, 526-3 associated with each computing device and/or computing node. For example, information sent from the input node 502 may pass through the first topology switch 526-1, through the I/O link, and through the second topology switch 526-2 to the destination node 504-1. In some embodiments, the first topology switch 526-1 directs the information to direct I/O link 508, and in some embodiments, the first topology switch 526-1 directs the information to the network switch 506 of the switched I/O link 510.

As described herein, the topology controller 528 may obtain a device inventory and/or data inventory for the distributed computing system. In some examples, the topology controller 528 obtains the device inventory and/or data inventory from an allocator 530 or other control plane. In some examples, the topology controller 528 obtains the device inventory and/or data inventory through communications with the computing devices and/or computing nodes of the distributed computing system 500.

In some embodiments, the topology controller 528 is in data communication with an allocator 530. The allocator 530 may be tasked with assigning portions of the computational task to computing nodes and/or computing devices of the distributed computing system 500 based at least partially on the computational process request. In some embodiments, the allocator 530 may allocate computing nodes and/or computing devices as part of the distributed computing system 500. In some embodiments, the allocator 530 allocates subprocesses to the computing nodes and/or computing devices of a predetermined distributed computing system 500. In some embodiments, the allocator 530 may include or be in communication with a machine learning model that determines at least part of the process allocations based on a computational process request.

FIG. 6 is schematic diagram of a machine learning model that may be trained to manage the topology and/or determine a topology request for the topology controller. In some embodiments, there are differences in performance and/or efficiency of different computing nodes and/or computing devices, even when the hardware is expected to be identical. A machine learning model, according to the present disclosure may receive feedback as to computing performance and/or efficiency to train and/or refine the machine learning model to better determine a topology request to allocate nodes and/or I/O links therebetween for performance and/or efficiency.

As used herein, a “machine learning model” for the purposes of managing the topology refers to a computer algorithm or model (e.g., a classification model, a regression model, a language model, an object detection model) that can be tuned (e.g., trained) based on training input to approximate unknown functions. For example, an ML model may refer to a neural network or other machine learning algorithm or architecture that learns and approximates complex functions and generate outputs based on a plurality of inputs provided to the machine learning model. In some embodiments, an ML system, model, or neural network described herein is an artificial neural network. In some embodiments, an ML system, model, or neural network described herein is a convolutional neural network. In some embodiments, an ML system, model, or neural network described herein is a recurrent neural network. In at least one embodiment, an ML system, model, or neural network described herein is a Bayes classifier. As used herein, a “machine learning system” may refer to one or multiple ML models that cooperatively generate one or more outputs based on corresponding inputs. For example, an ML system may refer to any system architecture having multiple discrete ML components that consider different kinds of information or inputs.

As used herein, an “instance” refers to an input object that may be provided as an input to a ML system to use in generating an output, such as processing rate or duration of a subprocess of a requested computational process. For example, an instance may refer to any processing metric for a computational process or subprocess. In some embodiments, the machine learning system has a plurality of layers with an input layer 638 configured to receive at least one input training dataset 634 or input training instance 636 and an output layer 642, with a plurality of additional or hidden layers 640 therebetween. The training datasets can be input into the machine learning system to train the machine learning system and identify individual and combinations of labels or attributes of the training instances. In some embodiments, the machine learning system can receive multiple training datasets concurrently and learn from the different training datasets simultaneously.

In some embodiments, the machine learning system includes a plurality of machine learning models that operate together. Each of the machine learning models has a plurality of hidden layers 640 between the input layer 638 and the output layer 642. The hidden layers 640 have a plurality of input nodes (e.g., nodes 644), where each of the nodes operates on the received inputs from the previous layer. In a specific example, a first hidden layer 640 has a plurality of nodes 644 and each of the nodes performs an operation on each instance 636 from the input layer 638. Each node of the first hidden layer 640 provides a new input into each node of the second hidden layer, which, in turn, performs a new operation on each of those inputs. The nodes of the second hidden layer then passes outputs, such as identified clusters 646, to the output layer 642.

In some embodiments, each of the nodes 644 has a linear function and an activation function. The linear function may attempt to optimize or approximate a solution with a line of best fit, such as reduced power cost or reduced latency. The activation function operates as a test to check the validity of the linear function. In some embodiments, the activation function produces a binary output that determines whether the output of the linear function is passed to the next layer of the machine learning model. In this way, the machine learning system can limit and/or prevent the propagation of poor fits to the data and/or non-convergent solutions.

The machine learning model includes an input layer that receives at least one training dataset. In some embodiments, at least one machine learning model uses supervised training. In some embodiments, at least one machine learning model uses unsupervised training. Unsupervised training can be used to draw inferences and find patterns or associations from the training dataset(s) without known outputs. In some embodiments, unsupervised learning can identify clusters of similar labels or characteristics for a variety of training instances and allow the machine learning system to extrapolate the performance of instances with similar characteristics.

In some embodiments, semi-supervised learning can combine benefits from supervised learning and unsupervised learning. As described herein, the machine learning system can identify associated labels or characteristics between instances, which may allow a training dataset with known outputs and a second training dataset including more general input information to be fused. Unsupervised training can allow the machine learning system to cluster the instances from the second training dataset without known outputs and associate the clusters with known outputs from the first training dataset.

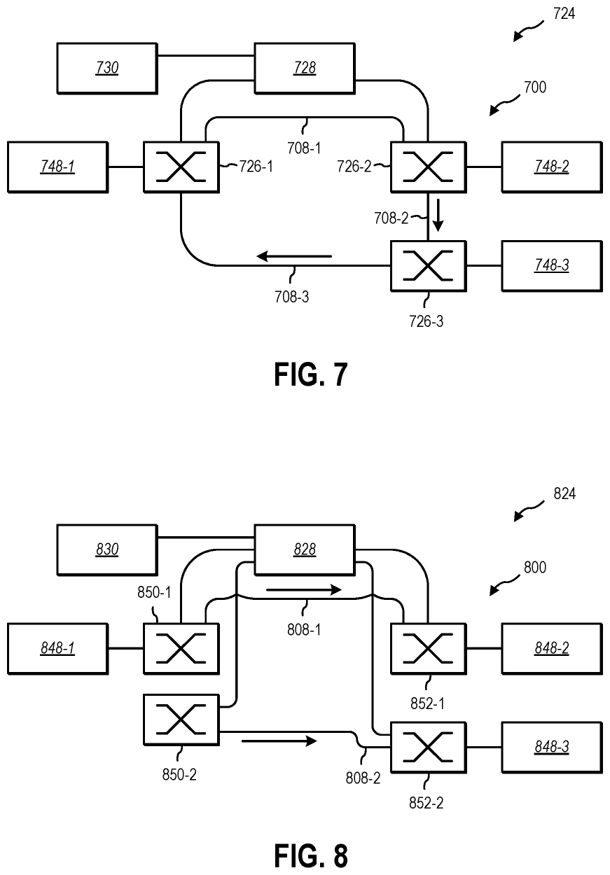

As described herein, in some embodiments, the topology request includes a fixed link topology. For example, a fixed link topology may include a ring topology, a tree topology, a star topology, a hierarchical topology, or other topologies. FIG. 7 is an example of a ring topology of an embodiment of a portion of a distributed computing system 700. In some embodiments, a system 724 for managing a distributed computing system includes a first topology switch 726-1 that provides communication from a first computing node 748-1 to a second computing node 748-2 through a first direct I/O link 708-1. A second direct I/O link 708-2 allows data communication from the second computing node 748-2 to a third computing node 748-3 through the second topology switch 726-2. A third direct I/O link 708-3 allows data communication from the third computing node 748-3 to the first computing node 748-1 through a third topology switch 726-3 to complete the ring topology. The topology controller 728 is in data communication with the topology switches 726-1, 726-2, 726-3 to configure the fixed link topology. In some embodiments, the topology controller 728 receives the topology request with the fixed link topology from an allocator 730.

FIG. 8 is an example of a tree topology of an embodiment of a portion of a distributed computing system 800. In some embodiments, a system 824 for managing a distributed computing system 800 includes a first input topology switch 850-1 that selectively provides communication from a first computing node 848-1 (input node) to a second computing node 848-2 (destination node) through a first direct I/O link 808-1. A second direct I/O link 808-2 allows data communication from the first computing node 848-1 (input node) to a third computing node 848-3 through a second input topology switch 850-2. The topology controller 828 is in data communication with the topology switches 850-1, 850-2, 852-1, 852-2 to configure the fixed link topology. In some embodiments, the topology controller 828 receives the topology request with the fixed link topology from an allocator 830.

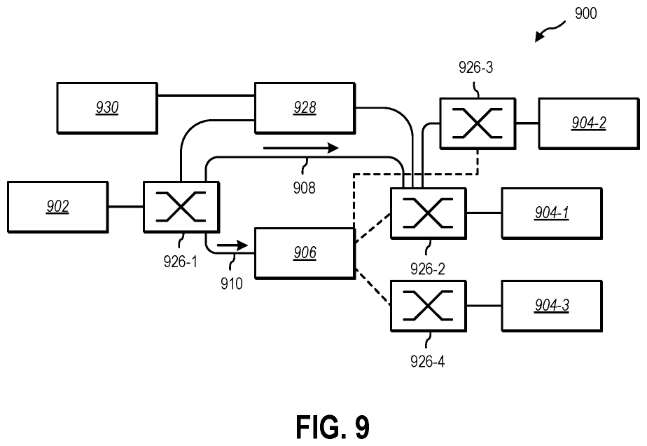

FIG. 9 is an example of a hybrid topology of an embodiment of a portion of a distributed computing system 900. In some embodiment, the topology controller 928 is in data communication with topology switches 926-1, 926-2, 926-3, 926-4 to configure the topology. In some embodiments, the topology controller 928 receives the topology request with the fixed link topology from an allocator 930. The topology controller 928 can actuate a first topology switch 926-1 to configure one of a direct I/O link 908 between the first topology switch 926-1 and a second topology switch 926-2 and a switched I/O link 910 between the first topology switch 926-1 and a network switch 906. In some embodiments, the second topology switch 926-2 can selectively provide an I/O link between a first destination node 904-1 and a third topology switch 926-3. In some embodiments, the first topology switch 926-1 can selectively configure a switched I/O link 910 between the first computing node (input node 902) and a network switch 906. The network switch 906 may provide packet routing to any of the topology switches 926-2, 926-3, 926-4 of the destination nodes 904-1, 904-2, 904-3.

By allowing dynamic reconfiguring of a topology of a distributed computing system, systems and methods according to the present disclosure may reduce power consumption and increase computational performance and efficiency for high performance computing.

### INDUSTRIAL APPLICABILITY

The present disclosure relates generally to systems and methods for increasing computational efficiency of a distributed computing system. More particularly, the present disclosure relates to a reconfigurable network and methods of reconfiguring the network to provide more efficient data communication between a plurality of computational nodes. In some embodiments, a distributed computing system or other high-performance computing (HPC) system includes a plurality of computational nodes, accelerators, or other computing devices that each perform a part of the total computational task. In some examples, the different computing devices of the distributed computing system contain identical hardware, such as processors, hardware storage devices including one or both of volatile memory and non-volatile memory, communication devices, power supplies, thermal management devices, and other electronic components. In some examples, the different computing devices of the distributed computing system contain different hardware, allowing certain computing devices to complete certain portions of the total computational task faster or more efficiently, such as consuming less electrical power or generating less heat.

In some embodiments, the distributed computing system allocates different portions of the computing task to different computing devices, and inputs and/or outputs of the different portions of the computing task are transmitted between the computing devices. For example, a first computing device of the distributed computing system performs a first portion of the computing task and transmits an output of the first portion to a second computing device as an input to the second portion of the computing task performed at the second computing device. In some examples, a specialized computing device performs a first portion of the computing task while obtaining inputs from a plurality of other computing devices on-demand. In some examples, the network topology (e.g., the communication links between the computing devices of the distributed computing system) change as needed for the computing task.

In some embodiments of a network according to the present disclosure, a topology controller manages one or more communication links in the distributed computing system based at least partially on a requested computing task and the computing devices of the distributed computing system that are available, contain relevant data, or are most efficient at performing certain functions.

In some embodiments, the requested computing task uses a plurality of computing devices for an extended period of time. For example, the requested computing task may include artificial intelligence (AI) tasks, such as generative AI or large language model (LLM) tasks, or the requested computing task may include training a machine learning model. For example, training a LLM on a corpus of data may require weeks of processing time. Increases in communication efficiency between computing devices of the distributed computing system may save hours or days of processing time of the total computational task.

Network switches, such as network switches, allow any of the computing devices to communicate with any other computing device in the distributed computing system. Network switching is a communication method where data is divided into smaller units called packets and transmitted through a communication link to another computing device. Each packet contains the source and destination addresses, as well as other information needed for routing through the network. The packets may take different paths to reach their destination, and they may be transmitted out of order or delayed due to network congestion. Network switching may result in further delays as the packets are received and recompiled at the destination. In some examples, packets are dropped, causing delays or errors in the transmitted information.

In some embodiments, a direct communication link provides a dedicated communication path through the network that is not subject to and/or less subject to network traffic and interference. For example, circuit switching is a communication method where a dedicated communication path, or circuit, is established between two devices before data transmission begins. The circuit remains dedicated to the communication for the duration of the session, and no other devices can use it while the session is in progress. Circuit switching can therefore reduce latency between a first computing device and a second computing device by eliminating competition on the same channels, where network switching may be delayed due to Quality of Service (QoS) levels or other competition for transmission time. Additionally, circuit switching can further reduce delays by reducing and/or eliminating time related to the division of the data into packets, recompiling of the packets, and any errors associated therewith.

Systems and methods according to the present disclosure include a topology controller receiving a computational task request for the distributed computing system. The topology controller is in data communication with one or more topology switches, such as cross-switches, that allow the topology controller to select and/or implement a network topology based at least partially on the requested computing task. In some embodiments, the topology controller is a dedicated computing device that controls the topology switches. In some embodiments, the topology controller is part of an allocator, such as a virtual machine allocator, or other control plane that controls the computing task(s) assigned to one or more of the computing devices in the distributed computing system.

In some embodiments, the distributed computing system is predefined, such as a distributed computing system including a plurality of computing devices and/or computing nodes co-located in a server rack, a server row, a datacenter, a region including a plurality of datacenters, etc. In some examples, the distributed computing system includes a variety of different computing devices and/or computing nodes with different hardware or software that allow some to be relatively more efficient at performing a particular computing task and/or allow for a more specialized operation of the different computing devices. For example, a first computing node may be relatively more efficient at graphical processing than a second computing node. In another example, a first computing node may be relatively more efficient at database querying and management than a second computing node.

In some embodiments, the distributed computing system is ad hoc, such as a distributed computing system including a plurality of general-purpose server computers that are selected and allocated to the requested computing task. In such examples, the general-purpose computers may have identical hardware and/or software. In some examples, the general-purpose computer may have different hardware or software that allows some to be relatively more efficient at performing a particular computing task and/or allow for a more specialized operation. In some embodiments, an ad hoc distributed computing system includes computing devices and/or computing nodes selected from a pool of available devices based at least partially on the hardware configuration and/or software configuration of the computing devices and/or computing nodes.

A device inventory includes information relating to the hardware configuration and/or software configuration of the computing devices and/or computing nodes. In some embodiments, a topology controller obtains a device inventory of the computing devices and/or computing nodes of the distributed computing system. For example, the topology controller may access the device inventory from another computing device, such as the allocator that allocates processes to the computing devices and/or computing nodes. In some examples, the topology controller has a device inventory stored locally on a hardware storage device of the topology controller. In some examples, the topology controller dynamically creates a device inventory based at least partially on available computing devices and/or computing nodes in the pool, such as available server computers within a datacenter.

The topology of the distributed computing system includes the number, endpoints, and types of I/O links in the distributed computing system. For example, the distributed computing system may include a plurality of computing devices, such as server blades. In some embodiments, a computing device is a computing node. In some embodiments, a computing device includes a plurality of computing nodes, such as multiple processors on a single server blade. The topology of the distributed computing system includes the I/O links between the computing nodes and, in some examples, the direction of the I/O links. For example, an I/O link between a first computing node and a second computing node may communicate data from the first computing node to the second computing node. In some examples, an I/O link between a first computing node and a second computing node may communicate data from the first computing node to the second computing node and from the second computing node to the first computing node.

While computing nodes in various systems and methods according to the present disclosure may refer to input nodes and destination nodes, it should be understood that any I/O link between the input node and the destination node may be bi-directional and the terms input node and destination node refer to the direction of communication of some information. For example, a first computing node may be an input node that inputs data to a first I/O link and a second computing node may be an destination node that receives the data from the first I/O link. The second computing node may then input data to the first I/O link and the first computing node may be the destination node that receives the data from the first I/O link. In another example, a first computing node may be an input node that inputs data to a first I/O link and a second computing node may be an destination node that receives the data from the first I/O link. The second computing node may then input data to a second I/O link and a third computing node may be an destination node that receives the data from the second I/O link.

The topology of the distributed computing system includes the type of I/O link between computing nodes. For example, the distributed computing system may include a direct I/O link, a switched I/O link, or other types of I/O links. In some embodiments, a direct I/O link is a circuit switched I/O link that provides a dedicated and substantially continuous I/O link between the first computing node and the second computing node. In some embodiments, a switched I/O link is a network switched I/O link that provides a versatile I/O link that can provide communication between a first computing node (e.g., input node) and a plurality of computing nodes (e.g., destination nodes), as needed. The latency of the direct I/O link is less than the latency of the switched I/O link. However, the direct I/O link commits networking and compute resources to the direct I/O link of the first computing node and the second computing node.

In some embodiments, a topology controller selects and/or changes a topology of the distributed computing system to reduce the total latency in the distributed computing system and improve communication efficiency and computing efficiency of the distributed computing system. For example, the topology controller selects a topology for the distributed computing system and changes at least one I/O link from a direct I/O link to a switched I/O link or at least one switched I/O link to a direct I/O link.

In some embodiments, the distributed computing system includes switched I/O links to provide the flexibility in communications. For example, an any-to-any topology is a distributed computing system in which all computing nodes are in data communication with one another via switched I/O links. The any-to-any topology allows communication between the input node and any destination node at any time by routing the data packets to the network switch, which then interprets information in the packet and routes the packet to the appropriate destination node. The destination node can then receive and recompile the packets.

While the any-to-any switched I/O link topology is versatile in communications, the latency associated with packet transmissions on the any-to-any switched I/O link topology is greater than 200 nanoseconds with many conventional network switches introducing a latency of 1 microsecond or more just for header processing to direct the packets. In some embodiments, dropped packets and/or recompiling can introduce additional latency and/or errors.

In some embodiments, the distributed computing system includes direct I/O links to provide low latency communications between input nodes and destination nodes. In examples where the first computing node and the second computing node are transmitting large blocks of data therebetween or frequent communications therebetween, the direct I/O links can allow faster communication with lower latency than a switched I/O link. For example, a direct I/O link may have a latency of approximately 1 nanosecond between the input node and the destination node. Additionally, direct I/O links may allow less opportunities for errors in the transmission, as the direct I/O links do not require dividing the data into packets, nor does the transmission pass through multiple potential routes to the destination node.

In some embodiments, a mixed topology of a distributed computing system includes some direct I/O links and some switched I/O links. For example, the input node has a plurality of direct I/O links between the input node and the first destination node allowing for low-latency, high reliability data communication, and the input node has a plurality of switched I/O links through a network switch that allow packets to be routed to any of a plurality of computing nodes in the distributed computing system. In some embodiments of systems and methods according to the present disclosure, a distributed computing system changes at least a portion of the topology based at least partially on an assigned computing task.

In some embodiments, a method of managing a topology of a distributed computing system includes receiving a topology request at a topology controller. In some embodiments, receiving a topology request includes receiving a computational process request at the topology controller, and the topology controller calculates or determines a topology request based at least partially on the computational process request. The computational process may be a computational task or a portion of a computational task. The computational process request may inform the topology controller of the subprocesses and/or subtasks required in the computational process. In some embodiments, the computational process request informs the topology controller of the amount of data being processed. In some embodiments, the computational process request informs the topology controller of the quantity of computing nodes required.

In some embodiments, receiving a topology request at a topology controller includes receiving the topology request from an allocator or other module that calculates or determines the topology request based at least partially on the computational process request. In some embodiments, as will be described herein, the topology request is determined by a machine learning model. In some embodiments, the topology request includes a fixed link topology. For example, a fixed link topology may include a ring topology, a tree topology, a star topology, a hierarchical topology, or other topologies.

Based at least partially on the topology request, the method further includes selecting an I/O link connecting an input node to a destination node from a plurality of I/O links. The selected I/O link is one of at least a direct link between the input node and the destination node and a switched link between the input node and the destination node, such as described herein.

In some embodiments, selecting the I/O link is based at least partially on a device inventory. A device inventory includes information relating to the hardware configuration and/or software configuration of the computing devices and/or computing nodes. In some embodiments, a topology controller obtains a device inventory of the computing devices and/or computing nodes of the distributed computing system. For example, the topology controller may access the device inventory from another computing device, such as the allocator that allocates processes to the computing devices and/or computing nodes. In some examples, the topology controller has a device inventory stored locally on a hardware storage device of the topology controller. In some examples, the topology controller dynamically creates a device inventory based at least partially on available computing devices and/or computing nodes in the pool, such as available server computers within a datacenter.

In some embodiments, selecting the I/O link is based at least partially on a data inventory. A data inventory includes information relating to the data stored on various hardware storage devices of the distributed computing system. For example, different computing devices of the distributed computing system may have different data stored thereon. In instances where computations are to be performed on the stored data, the stored data may need to be transferred to another computing node of the distributed computing system for more or most efficient processing. In at least one example, selecting the I/O link(s) include referencing both a data inventory and device inventory to select an I/O link from an input node (e.g., containing data based at least partially on the data inventory) to a destination node (e.g., based at least partially on the device inventory) for processing.

Selecting the I/O link is based at least partially on a computational process request. In some embodiments, the computational process request includes a specialized computational subprocess that is more efficiently performed on a specialized computing node, which affects the topology request. In some embodiments, the computational process request includes computational subprocesses that are performed in sequence, such as each output being an input into a future subprocess. In the event that the output of a first subprocess is consistently provided as an input to a second subprocess, the topology request may instruct the topology controller to establish a direct I/O link between a first computing node performing the first subprocess such that the output is transmitted on the direct I/O link to a second computing node performing the second subprocess.

In some embodiments, the method further includes configuring an active I/O link between the input node and the destination node based on the selected I/O link with a topology switch. In some embodiments, configuring the active I/O link includes actuating the topology switch, such as a cross-point switch. For example, a 2×2 cross-point switch allows recabling of the active I/O link. In an example, the method includes changing a switched I/O link to a direct I/O link by bypassing the network switch with a cross-point switch. In some embodiments, actuating the topology switch introduces latency into the topology of the distributed computing system because the actuation and recabling requires an actuation time that may be orders of magnitude longer than the latency associate with network switching. However, the reduction in latency of the direct I/O link when the versatility of a switched I/O link is not necessary can quickly compensate for the 1-2 millisecond actuation time. In some embodiments, the method further includes transmitting data on the active I/O link from the input node to the destination node.

In some embodiments, the method further allows the topology controller to send instructions and/or commands to power down the network switches (e.g., network switches) of the switched I/O links when the network switches are not used. For example, when the active I/O link is a direct I/O link and bypasses the network switch, the topology controller may provide instructions to power down or place into a standby state the network switch, conserving power. In some embodiments, the topology controller transmits the instructions to the network switch to power down the network switch. In some embodiments, the topology controller transmits the instructions to a rack manager, row manager, or other control plane in data communication with the network switch to power down the network switch.

In some embodiments, a distributed computing system according to the present disclosure includes at least one input node and a plurality of destination nodes. The distributed computing system includes I/O links that allow either direct I/O links or switched I/O links to be selectively configured between the input node and the destination node(s). In some embodiments, the distributed computing system includes at least one topology switch.

The topology switch allows the I/O link to be changed between states. In some embodiments, the topology switch physically recables a wired connection between the input node and the destination node. In some embodiments, the topology switch is a cross-point switch. In some embodiments, the cross-point switch is a 2×2 cross-point switch. In some embodiments, the cross-point switch is a 4×4, 8×8, 16×16, or greater cross-point switch. Increasing the size of the cross-point switch, however can limit the available space for computing devices and/or other electronic components of the distributed computing system. A 2×2 cross-point switch allows for the selection of a switched I/O link and a direct I/O link for a computing node and/or computing device without substantially impairing the available space for other devices. For example, the physical connection between the input node and the destination node may be made by electrical cables, such as active or passive DAC cables) running any network transport layer protocol (e.g., Ethernet, ROCE).

In some embodiments, the system includes a topology switch associated with each computing device and/or computing node. For example, information sent from the input node may pass through the first topology switch, through the I/O link, and through the second topology switch to the destination node. In some embodiments, the first topology switch directs the information through the direct I/O link, and in some embodiments, the first topology switch directs the information to the network switch of the switched I/O link.

As described herein, the topology controller may obtain a device inventory and/or data inventory for the distributed computing system. In some examples, the topology controller obtains the device inventory and/or data inventory from an allocator or other control plane. In some examples, the topology controller obtains the device inventory and/or data inventory through communications with the computing devices and/or computing nodes of the distributed computing system.

In some embodiments, the topology controller is in data communication with an allocator. The allocator may be tasked with assigning portions of the computational task to computing nodes and/or computing devices of the distributed computing system based at least partially on the computational process request. In some embodiments, the allocator may allocate computing nodes and/or computing devices as part of the distributed computing system. In some embodiments, the allocator allocates subprocesses to the computing nodes and/or computing devices of a predetermined distributed computing system. In some embodiments, the allocator may include or be in communication with a machine learning model that determines at least part of the process allocations based on a computational process request.

In some embodiments, there are differences in performance and/or efficiency of different computing nodes and/or computing devices, even when the hardware is expected to be identical. A machine learning model, according to the present disclosure may receive feedback as to computing performance and/or efficiency to train and/or refine the machine learning model to better determine a topology request to allocate nodes and/or I/O links therebetween for performance and/or efficiency.

As used herein, a “machine learning model” for the purposes of managing the topology refers to a computer algorithm or model (e.g., a classification model, a regression model, a language model, an object detection model) that can be tuned (e.g., trained) based on training input to approximate unknown functions. For example, an ML model may refer to a neural network or other machine learning algorithm or architecture that learns and approximates complex functions and generate outputs based on a plurality of inputs provided to the machine learning model. In some embodiments, an ML system, model, or neural network described herein is an artificial neural network. In some embodiments, an ML system, model, or neural network described herein is a convolutional neural network. In some embodiments, an ML system, model, or neural network described herein is a recurrent neural network. In at least one embodiment, an ML system, model, or neural network described herein is a Bayes classifier. As used herein, a “machine learning system” may refer to one or multiple ML models that cooperatively generate one or more outputs based on corresponding inputs. For example, an ML system may refer to any system architecture having multiple discrete ML components that consider different kinds of information or inputs.

As used herein, an “instance” refers to an input object that may be provided as an input to a ML system to use in generating an output, such as processing rate or duration of a subprocess of a requested computational process. For example, an instance may refer to any processing metric for a computational process or subprocess. In some embodiments, the machine learning system has a plurality of layers with an input layer configured to receive at least one input training dataset or input training instance and an output layer, with a plurality of additional or hidden layers therebetween. The training datasets can be input into the machine learning system to train the machine learning system and identify individual and combinations of labels or attributes of the training instances. In some embodiments, the machine learning system can receive multiple training datasets concurrently and learn from the different training datasets simultaneously.

In some embodiments, the machine learning system includes a plurality of machine learning models that operate together. Each of the machine learning models has a plurality of hidden layers between the input layer and the output layer. The hidden layers have a plurality of input nodes (e.g., nodes), where each of the nodes operates on the received inputs from the previous layer. In a specific example, a first hidden layer has a plurality of nodes and each of the nodes performs an operation on each instance from the input layer. Each node of the first hidden layer provides a new input into each node of the second hidden layer, which, in turn, performs a new operation on each of those inputs. The nodes of the second hidden layer then passes outputs, such as identified clusters, to the output layer.

In some embodiments, each of the nodes has a linear function and an activation function. The linear function may attempt to optimize or approximate a solution with a line of best fit, such as reduced power cost or reduced latency. The activation function operates as a test to check the validity of the linear function. In some embodiments, the activation function produces a binary output that determines whether the output of the linear function is passed to the next layer of the machine learning model. In this way, the machine learning system can limit and/or prevent the propagation of poor fits to the data and/or non-convergent solutions.

The machine learning model includes an input layer that receives at least one training dataset. In some embodiments, at least one machine learning model uses supervised training. In some embodiments, at least one machine learning model uses unsupervised training. Unsupervised training can be used to draw inferences and find patterns or associations from the training dataset(s) without known outputs. In some embodiments, unsupervised learning can identify clusters of similar labels or characteristics for a variety of training instances and allow the machine learning system to extrapolate the performance of instances with similar characteristics.

In some embodiments, semi-supervised learning can combine benefits from supervised learning and unsupervised learning. As described herein, the machine learning system can identify associated labels or characteristic between instances, which may allow a training dataset with known outputs and a second training dataset including more general input information to be fused. Unsupervised training can allow the machine learning system to cluster the instances from the second training dataset without known outputs and associate the clusters with known outputs from the first training dataset.

As described herein, in some embodiments, the topology request includes a fixed link topology. For example, a fixed link topology may include a ring topology, a tree topology, a star topology, a hierarchical topology, or other topologies. In some embodiments, a system for managing a distributed computing system includes a first topology switch that provides communication from a first computing node to a second computing node through a direct I/O link. A second direct I/O link allows data communication from the second computing node to a third computing node through the second topology switch. A third direct I/O link allows data communication from the third computing node to the first computing node through a third topology switch to complete the ring topology. The topology controller is in data communication with the topology switches to configure the fixed link topology. In some embodiments, the topology controller receives the topology request with the fixed link topology from an allocator.

In some embodiments, a system for managing a distributed computing system includes a first input topology switch that selectively provides communication from a first computing node (input node) to a second computing node (destination node) through a first direct I/O link. A second direct I/O link allows data communication from the first computing node (input node) to a third computing node through a second input topology switch. The topology controller is in data communication with the topology switches to configure the fixed link topology. In some embodiments, the topology controller receives the topology request with the fixed link topology from an allocator.

In some embodiment, the topology controller is in data communication with topology switches to configure the topology. In some embodiments, the topology controller receives the topology request with the fixed link topology from an allocator. The topology controller can actuate a first topology switch to configure one of a direct I/O link between the first topology switch and a second topology switch and a switched I/O link between the first topology switch and a network switch. In some embodiments, the second topology switch can selectively provide an I/O link between a first destination node and a third topology switch. In some embodiments, the first topology switch can selectively configure a switched I/O link between the first computing node (input node) and a network switch. The network switch may provide packet routing to any of the topology switches of the destination nodes.

By allowing dynamic reconfiguring of a topology of a distributed computing system, systems and methods according to the present disclosure may reduce power consumption and increase computational performance and efficiency for high performance computing.

The present disclosure relates to systems and methods for managing the topology of a distributed computing system according to at least the examples provided in the clauses below:

Clause 1. A method of managing communication between computing nodes, the method comprising: at a topology controller: receiving a topology request at the topology controller; based at least partially on the topology request, selecting an input-output (I/O) link connecting an input node to a destination node from a plurality of I/O links including at least: a direct link I/O between the input node and the destination node, and a switched I/O link between the input node and the destination node; and configuring an active I/O link between the input node and the destination node based on the selected I/O link.

Clause 2. The method of clause 1, wherein configuring the I/O link includes actuating a cross-point switch.

Clause 3. The method of any of clause 1 or 2, wherein the topology request is received from the input node.

Clause 4. The method of any of clauses 1-3, wherein the direct link directly connects a first connector of the input node to a second connector of the destination node.

Clause 5. The method of any of clauses 1-4, wherein the switched link connects a first topology switch of the input node to a network switch and connects the network switch to a second topology switch of the destination node.

Clause 6. The method of any of clauses 1-5, wherein selecting a direct link between the input node and the destination node includes configuring a plurality of direct links between the input node and the destination node based at least partially on the topology request.

Clause 7. The method of any of clauses 1-6, wherein configuring the active I/O link includes changing a physical connection between a first connector of the input node to a second connector of the destination node.

Clause 8. The method of any of clauses 1-7, wherein selecting a direct link includes selecting a fixed link topology.

Clause 9. The method of clause 8, wherein the fixed link topology is selected from a group including ring, tree, star, and hierarchical.

Clause 10. The method of clause 8, wherein the fixed link topology includes at least one network switch.

Clause 11. The method of any of clauses 1-10, further comprising, after configuring the active I/O link to a direct I/O link, powering down a network switch of the switched I/O link.

Clause 12. A system for managing a topology of a distributed computing system, the system comprising: an input node; a destination node; a first topology switch associated with the input node and in data communication with the input node; a second topology switch associated with the destination node and in data communication with the destination node; and a topology controller configured to actuate at least the first topology switch to selectively direct information from the input node to one of: a direct I/O link between the first topology controller and the second topology controller, and a switched I/O link between the first topology controller and the second topology controller.

Clause 13. The system of clause 12, wherein the topology controller is in data communication with an allocator.

Clause 14. The system of clause 12, wherein the topology controller is part of an allocator.

Clause 15. The system of any of clauses 12-14, wherein the topology controller is configured to actuate at least the first topology switch to selectively direct information based at least partially on a topology request received at the topology controller.

Clause 16. The system of any of clauses 12-15, wherein at least one of the first topology switch and the second topology switch is a cross-point switch.

Clause 17. The system of any of clauses 12-16, wherein the switched I/O link includes a network switch.

Clause 18. The system of any of clauses 12-17, wherein the network switch has a latency greater than 200 nanoseconds.

Clause 19. A method of managing communication between computing nodes, the method comprising: receiving a computational process request at a machine learning model; determining at least part of a topology request with the machine learning model; and at a topology controller: receiving the topology request at the topology controller; based at least partially on the computational process request, selecting an input-output (I/O) link connecting an input node to a destination node from a plurality of I/O links including at least: a direct I/O link between the input node and the destination node, and a switched I/O link between the input node and the destination node; and configuring an active I/O link between the input node and the destination node based on the selected I/O link.

Clause 20. The method of clause 19, wherein the machine learning model is further in communication with an allocator.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the scope of the present disclosure, and that various changes, substitutions, and alterations may be made to embodiments disclosed herein without departing from the scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims. It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of managing communication between computing nodes, the method comprising:
at a topology controller:
receiving a topology request at the topology controller;
based at least partially on the topology request, selecting an input-output (I/O) link connecting an input node to a destination node from a plurality of I/O links including at least:
a direct I/O link between the input node and the destination node, and
a switched I/O link between the input node and the destination node; and
configuring an active I/O link between the input node and the destination node based on the selected I/O link.

2. The method of claim 1, wherein configuring the active I/O link includes actuating a cross-point switch.

3. The method of claim 1, wherein the topology request is received from the input node.

4. The method of claim 1, wherein the direct I/O link directly connects a first topology switch of the input node to a second topology switch of the destination node.

5. The method of claim 1, wherein the switched I/O link connects a first topology switch of the input node to a network switch and connects the network switch to a second topology switch of the destination node.

6. The method of claim 1, wherein selecting a direct link between the input node and the destination node includes configuring a plurality of direct links between the input node and the destination node based at least partially on the topology request.

7. The method of claim 1, wherein configuring the active I/O link includes changing a physical connection between a first connector of the input node to a second connector of the destination node.

8. The method of claim 1, wherein selecting a direct link includes selecting a fixed link topology.

9. The method of claim 8, wherein the fixed link topology is selected from a group including ring, tree, star, and hierarchical.

10. The method of claim 8, wherein the fixed link topology includes at least one network switch.

11. The method of claim 1, further comprising, after configuring the active I/O link to a direct I/O link, powering down a network switch of the switched I/O link.

12. A system for managing a topology of a distributed computing system, the system comprising:
an input node;
a destination node;
a first topology switch associated with the input node and in data communication with the input node;
a second topology switch associated with the destination node and in data communication with the destination node; and
a topology controller configured to actuate at least the first topology switch to selectively direct information from the input node to one of:
a direct I/O link between the first topology controller and the second topology controller, and
a switched I/O link between the first topology controller and the second topology controller.

13. The system of claim 12, wherein the topology controller is in data communication with an allocator.

14. The system of claim 12, wherein the topology controller is part of an allocator.

15. The system of claim 12, wherein the topology controller is configured to actuate at least the first topology switch to selectively direct information based at least partially on a topology request received at the topology controller.

16. The system of claim 12, wherein at least one of the first topology switch and the second topology switch is a cross-point switch.

17. The system of claim 12, wherein the switched I/O link includes a network switch.

18. The system of claim 17, wherein the network switch has a latency greater than 200 nanoseconds.

19. A method of managing communication between computing nodes, the method comprising:
receiving a computational process request at a machine learning model;
determining at least part of a topology request with the machine learning model; and
at a topology controller:
receiving the topology request at the topology controller;
based at least partially on the computational process request, selecting an input-output (I/O) link connecting an input node to a destination node from a plurality of I/O links including at least:
a direct I/O link between the input node and the destination node, and
a switched I/O link between the input node and the destination node; and
configuring an active I/O link between the input node and the destination node based on the selected I/O link.

20. The method of claim 19, wherein the machine learning model is further in communication with an allocator.
